(19) United States
(12) Patent Application Publication
(10) Pub. No.: US 2009/0095526 A1
(43) Pub. Date: Apr. 16, 2009

(54) Method and Apparatus for Managing Rod Changes in Horizontal Directional Drill

(76) Inventors: Philip R. Lane, Pella, IA (US); Scott A. Johnson, Oskaloosa, IA (US); Douglas Peirce, Pleasant Hill, IA (US)

Correspondence Address: Hollingsworth & Funk, LLC, Suite 125, 8009 34th Avenue South, Minneapolis, MN, 55425, US

(21) Appl. No.: 12/252,879

(22) Filed: Oct. 16, 2008

Related U.S. Application Data
(60) Provisional application No. 60/999,324, filed on Oct. 16, 2007.
(60) Provisional application No. 60/999,326, filed on Oct. 16, 2007.

(51) Int. Cl. E21B 19/14; E21B 19/08; E21B 19/15; E21B 44/00; E21B 7/04; G06F 19/00

(52) U.S. Cl. 175/24; 175/40; 414/22.62; 700/275

(57) ABSTRACT

This disclosure concerns methods and apparatuses for managing drill rods in horizontal direction drilling, among other things. Various embodiments concern a horizontal directional drilling machine comprising a rack frame, a carriage longitudinally movable along the rack frame, a mechanical arrangement coupled to the carriage and the rack frame, the mechanical arrangement controlling relative movement between the carriage and the rack frame, a thrust motor coupled to the carriage such that thrust or pullback output from the thrust motor moves the carriage relative to the rack frame, a gearbox mounted on the carriage, the gearbox longitudinally translatable along the carriage, the gearbox comprising a rotation motor, a spindle attached to the gearbox, the spindle rotatable by the rotation motor and having a distal end coupling, the distal end coupling configured to attach to the proximal end of a drill rod, a vise assembly mounted on the rack frame, the vise assembly comprising a proximal vise linearly and rotationally moveable with respect to the rack frame, the proximal vise comprising a clamping mechanism configured to secure the drill rod by clamping onto the drill rod, a rotation encoder sensor configured to output a rotation encoder signal indicative of rotation of the spindle, a rack encoder sensor configured to output a rack encoder signal indicative of relative movement between the carriage and the rack frame, a float sensor configured to output a float signal indicative of relative movement between the carriage and the gearbox, and control circuitry comprising a processor and memory, the processor configured to execute program instructions stored in memory, processor execution of the stored program instructions causing the control circuitry to determine the relative positioning of the gearbox relative to the proximal vise based on the rack encoder signal and the float signal, position the drill rod within the proximal vise using the determined relative positioning of the gearbox and the thrust motor, determine a state of threaded coupling between the drill rod and a drill string based on the rotation encoder signal and the float signal, and rotate the drill rod using the spindle rotated by the rotation motor based on the determined state of the threaded coupling.

### RELATED APPLICATIONS

This application claims the benefit of Provisional Patent Application Ser. No. 60/999,324, filed on Oct. 16, 2007, and Ser. No. 60/999,326, filed on Oct. 16, 2007, to which Applicant claims benefit of priority under 35 U.S.C. § 119(e), and which are incorporated herein by reference in their entireties.

### TECHNICAL FIELD

The present invention relates generally to equipment used for horizontal ground boring; more specifically to determining rack position on a horizontal directional drill; more particularly still to methods and apparatuses for controlling the movement of a carriage on a rack based on the position of the carriage during horizontal directional drilling; and more specifically to automatically making up or breaking out drill rod joints for horizontal directional drilling.

### BACKGROUND

Utility lines for water, electricity, gas, telephone and cable television are often run underground for reasons of safety and aesthetics. Sometimes, the underground utilities are buried in a trench that is then back filled. However, trenching can be time consuming and can cause substantial damage to existing structures or roadways. Horizontal directional drilling, commonly referred to as HDD, is a process used in applications such as installing utilities underground. Generally the first step in the HDD process includes boring a pilot hole. In this step a bore hole is created that extends underground—generally horizontally or parallel to the surface of the earth—starting at a launch point and ending at a termination point.

The bore hole is created by a boring machine that rotates and pushes a drill string through the ground. A drill bit is attached to the leading end of the drill string. The drill string is formed by connecting individual drill rods together end-to-end from a supply of drill rods stored on the boring machine. The connection between the rods is made up, and subsequently broken in a later step, by the boring machine. Typically, an operator manually controls the drill string as it is pushed or pulled from the ground. The operator visually monitors the drill string as it advances and retracts and determines when drill rods need to be added (made up) or removed (broken out) from the drill string.

A boring machine can include a gearbox that connects to the drill string, a carriage on which the gearbox resides, a rack on which the gearbox moves, a vise, a drill rod storage magazine, and a rod loading mechanism. The rod loading mechanism moves the individual drill rods from the storage magazine into alignment with the drill string and the gearbox where the individual drill rod is connected to and made a part of the drill string. Rod loading mechanisms typically include a rod transfer mechanism that moves the rod from the storage magazine and positions it with one end in alignment with the drill string and the other end in alignment with the gearbox. The drill rods are typically long, and are stored with their longitudinal axes parallel to one another. An automatic rod loader apparatus of the type disclosed in commonly assigned U.S. Pat. No. 5,556,253, which is hereby incorporated herein by reference in its entirety, may be used in embodiments referenced herein.

To push the drill string into the earth, the carriage is moved from a point on the rack that is distal from the vise to a point on the rack that is proximal to the vise. A stop is generally located on the machine so that the carriage does not physically engage the vise. Although in the case of a hydraulic system, valves and sensors may be employed to limit the stress, nevertheless, a drawback exists in that the stop may be encountered unexpectedly and/or at a rate of movement that may put stress on one or more components of the machine.

Therefore, there is a need in the art for a method and apparatus for determining the rack position of the carriage and for optionally controlling the movement of the carriage as it approaches predetermined positions on the carriage. The present invention overcomes the shortcomings of the prior art and addresses these needs in the art.

### SUMMARY

The present invention generally relates to a method and apparatus for determining the rack position of the carriage and for optionally controlling the movement of the carriage as it approaches predetermined positions on the carriage, particularly those positions suitable for making up and breaking out drill rods.

Various systems and methods involve employing sensors to automatically monitor a number of dimensions, and a processor that automatically breaks out or makes up rods from the drill string, as appropriate.

In one embodiment of the constructed in accordance with the principles of the present invention, there is provided an absolute encoder or position sensor to determine the distance between the vise end of the rack and the vise end of the carriage. In this method of measurement, when the vise end of the carriage is touching the vise end of the rack (e.g., is positioned at the stop), then the distance equals zero. As the carriage moves away from the vise, then the rack distance increases. It will be appreciated that other distances from predetermined positions on the rack may also be measured.

In one embodiment, as the carriage approaches the proximal or distal position from the vise end on the rack, the thrust or pullback outputs may be controlled respectively. For example, the outputs may be reduced to slow the carriage speed as it approaches the mechanical stops and/or other predetermined positions. The reduction may be performed proportionally to slow the carriage in a linear fashion, or some other relationship may be used. When the carriage reaches the mechanical stops, the output may be reduced to zero.

Various apparatus embodiments concern a horizontal directional drilling machine comprising a rack frame, a carriage longitudinally movable along the rack frame, a mechanical arrangement coupled to the carriage and the rack frame, the mechanical arrangement controlling relative movement between the carriage and the rack frame, a thrust motor coupled to the carriage such that thrust or pullback output from the thrust motor moves the carriage relative to the rack frame, a gearbox mounted on the carriage, the gearbox longitudinally translatable along the carriage, the gearbox comprising a rotation motor, a spindle attached to the gearbox, the spindle rotatable by the rotation motor and having a distal end coupling, the distal end coupling configured to attach to the proximal end of a drill rod, a vise assembly mounted on the rack frame, the vise assembly comprising a proximal vise linearly and rotationally moveable with respect to the rack frame, the proximal vise comprising a clamping mechanism configured to secure the drill rod by clamping onto the drill rod, a rotation encoder sensor configured to output a rotation encoder signal indicative of rotation of the spindle, a rack encoder sensor configured to output a rack encoder signal indicative of relative movement between the carriage and the rack frame, a float sensor configured to output a float signal indicative of relative movement between the carriage and the gearbox, and control circuitry comprising a processor and memory, the processor configured to execute program instructions stored in memory, processor execution of the stored program instructions causing the control circuitry to determine the relative positioning of the gearbox relative to the proximal vise based on the rack encoder signal and the float signal, position the drill rod within the proximal vise using the determined relative positioning of the gearbox and the thrust motor, determine a state of threaded coupling between the drill rod and a drill string based on the rotation encoder signal and the float signal, and rotate the drill rod using the spindle rotated by the rotation motor based on the determined state of the threaded coupling.

Such an apparatus embodiment may further include a mechanical arrangement that applies a force between the gearbox and the carriage, the mechanical arrangement pushing the gearbox in the distal direction relative to the carriage using the force, wherein processor execution of the stored program instructions may cause the control circuitry to change the output of the thrust motor based in part on the position of the gearbox along the carriage as indicated by the float signal.

In such apparatus embodiments, processor execution of the stored program instructions may cause the control circuitry to increase thrust motor output when the float signal indicates that the gearbox is in a first position relative to the carriage and reduce thrust motor output when the float signal indicates that the gearbox is in a second position relative to the carriage, wherein the first position is distal of the second position.

In such apparatus embodiments, processor execution of the stored program instructions may cause the control circuitry to determine the number of turns the distal end coupling is threaded into the proximal end of the drill rod by counting the number of revolutions of the spindle as indicated by the rotation encoder sensor when the float signal indicates that the gearbox has moved proximally with respect to the carriage after a change in output by the thrust motor.

In such apparatus embodiments, processor execution of the stored program instructions may cause the control circuitry to decrease output of the thrust motor based on the determined number of turns the distal end coupling is threaded into the proximal end reaching a predetermined value, the predetermined value based on the quantity of threads in the proximal end of the drill rod.

In such apparatus embodiments, the vise assembly may further comprise a distal vise distal of the proximal vise and processor execution of the stored program instructions may cause the control circuitry to clamp the distal vise around the proximal end of the drill string, rotate the spindle by increasing the output of the rotation motor, determine the number of turns the distal end coupling is threaded into the proximal end of the drill rod by counting the number of revolutions of the spindle as indicated by the rotation encoder sensor when the float signal indicates that the gearbox has moved proximally with respect to the carriage after a change in output by the thrust motor that moves the distal end coupling of the spindle toward the proximal end of the drill rod, and reduce the output of the rotation motor based on the determined number of turns the distal end coupling is threaded into the proximal end of the drill rod reaching a predetermined value, the predetermined value based on the quantity of threading in the proximal end of the drill rod.

In such apparatus embodiments, processor execution of the stored program instructions may cause the control circuitry to increase thrust motor output when the float signal indicates that the gearbox is in a first position relative to the carriage and reduce thrust motor output when the float signal indicates that the gearbox is in a second position relative to the carriage while the distal end coupling is threaded into the proximal end of the drill rod, wherein the first position is distal of the second position with respect to the carriage.

In such apparatus embodiments, the vise assembly may further comprise a distal vise distal of the proximal vise and processor execution of the stored program instructions may cause the control circuitry to move the drill string by controlling the output of the thrust motor so that a proximal end of the drill string is within the distal vise as indicated by the rack encoder signal, clamp the distal vise around the proximal end of the drill string and clamp the proximal vise onto the drill rod, rotate the proximal vise relative to the distal vise, unclamp the proximal vise, move the drill rod to a predetermined position by controlling the output of the thrust motor, the output of the thrust motor based on the rack encoder signal indicating the position of the drill string with respect to the proximal vise, clamp the proximal vise onto the drill rod while the drill rod is in the predetermined position as indicated by the rack encoder signal, rotate the spindle relative to the drill rod while determining the number of turns the distal end coupling is unthreaded from the proximal end of the drill rod by counting the number of revolutions of the spindle as indicated by the rotation encoder sensor, and expand a distance between the proximal vise and the distal end coupling of the spindle by increasing output of the thrust motor based on the rack encoder sensor.

In such apparatus embodiments, the vise assembly may further comprise a distal vise distal of the proximal vise and processor execution of the stored program instructions may cause the control circuitry to store in memory rack encoder signal values and float signal values indicating the relative positioning of the carriage relative to the rack and the carriage relative to the gearbox in each of the following positions and control output of the thrust motor to have the horizontal directional drilling machine assume each of these positions upon receiving one or more signals: the drill rod is within the proximal vise while a drill string to which the drill rod is attached is within the distal vise, the drill rod is within the proximal vise while the drill rod is unattached to the drill string and the distal end coupling of the spindle is threadedly coupled to the proximal end of the drill rod, and the drill rod is within the proximal vise while the distal end coupling of the spindle is unattached to the proximal end of the drill rod.

Method embodiments for horizontal directional drilling may comprise providing a horizontal directional drilling machine having rack frame, a carriage longitudinally movable along the rack frame, a mechanical arrangement that controls relative movement between the carriage and the rack frame coupled to the carriage and the rack frame, a thrust motor coupled to the carriage such that thrust or pullback output from the thrust motor moves the carriage relative to the rack frame, a gearbox mounted on the carriage in a manner such that the gearbox is longitudinally movable along the carriage, a spindle attached to the gearbox, a rotation motor that rotates the spindle, and a distal end coupling of the spindle configured to attach to the proximal end of a drill rod, and a proximal vise that is linearly and rotationally moveable with respect to the rack frame, outputting a rotation encoder signal from a rotation encoder sensor, the rotation encoder signal indicative of rotation of the spindle, outputting a rack encoder signal from a rack encoder sensor, the rack encoder signal indicative of relative movement between the carriage and the rack frame, outputting a float signal from a float sensor, the float signal indicative of relative movement between the carriage and the gearbox, determining the relative positioning of the spindle relative to the proximal vise based on the rack encoder signal and the float signal, moving the drill rod within the proximal vise based on the determined relative positioning of the spindle and the thrust motor, determining a state of threaded coupling between the drill rod and a drill string based on the rotation encoder signal and the float signal, and rotating the drill rod using the spindle rotated by the rotation motor, rotation of the drill rod based on the determined state of the threaded coupling.

Such a method embodiment may comprise applying a force between the gearbox and the carriage that pushes the gearbox in the distal direction relative to the carriage, and changing the output of the thrust motor based in part on the position of the gearbox along the carriage as indicated by the float signal.

Such a method embodiment may comprise increasing thrust motor output when the float signal indicates that the gearbox is in a first position relative to the carriage, and reducing thrust motor output when the float signal indicates that the gearbox is in a second position relative to the carriage, wherein the first position is distal of the second position.

Such a method embodiment may comprise determining the number of turns the distal end coupling is threaded into the proximal end of the drill rod by counting the number of revolutions of the spindle as indicated by the rotation encoder sensor when the float signal indicates that the gearbox has moved proximally with respect to the carriage after a change in output by the thrust motor.

Such a method embodiment may comprise decreasing output by the thrust motor based on the determined number of turns the distal end coupling is threaded into the proximal end reaching a predetermined value, the predetermined value based on the quantity of threads in the proximal end of the drill rod.

Such a method embodiment may comprise providing a distal vise distal of the proximal vise, clamping the distal vise around the proximal end of the drill string, rotating the spindle by increasing the output of the rotation motor, determining the number of turns the distal end coupling is threaded into the proximal end of the drill rod by counting the number of revolutions of the spindle as indicated by the rotation encoder sensor when the float signal indicates that the gearbox has moved proximally with respect to the carriage after a change in output by the thrust motor that moves the distal end coupling of the spindle toward the proximal end of the drill rod, and reducing the output of the rotation motor based on the determined number of turns the distal end coupling is threaded into the proximal end of the drill rod reaching a predetermined value, the predetermined value based on the quantity of threads in the proximal end of the drill rod.

Such a method embodiment may comprise increasing thrust motor output when the float signal indicates that the gearbox is in a first position relative to the carriage, and reducing thrust motor output when the float signal indicates that the gearbox is in a second position relative to the carriage while the distal end coupling is threaded into the proximal end of the drill rod, wherein the first position is distal of the second position.

Such a method embodiment may comprise providing a distal vise distal of the proximal vise, moving the drill string by controlling the output of the thrust motor so that a proximal end of the drill string is within the distal vise as indicated by the rack encoder signal, clamping the distal vise onto the proximal end of the drill string and clamping the proximal vise onto the drill rod, rotating the proximal vise relative to the distal vise to loosen threading between the drill rod and the drill string, unclamping the proximal vise, moving the drill rod to a predetermined position by controlling the output of the thrust motor, the output of the thrust motor based on the rack encoder signal indicating the position of the drill string with respect to the proximal vise, clamping the proximal vise onto the drill rod while the drill rod is in the predetermined position as indicated by the rack encoder signal, rotating the spindle relative to the drill rod while determining state of unthreading the proximal end of the drill rod based on a change in the float signal during rotation of the spindle, and expanding a distance between the proximal vise and the distal end coupling of the spindle by increasing output of the thrust motor based on the rack encoder sensor.

Such a method embodiment may comprise providing a distal vise distal of the proximal vise, saving rack encoder signal values and float signal values indicating the relative positioning of the carriage relative to the rack and the carriage relative to the gearbox when: the horizontal directional drilling machine is in a first position, wherein the drill rod is within the proximal vise while a drill string to which the drill rod is attached is within the distal vise, the horizontal directional drilling machine is in a second position, wherein the drill rod is within the proximal vise while the drill rod is unattached to the drill string and the distal end coupling of the spindle is threadedly coupled to the proximal end of the drill rod, and the horizontal directional drilling machine is in a third position, wherein the drill rod is within the proximal vise while the distal end coupling of the spindle is unattached to the proximal end of the drill rod, and the method embodiment may further include moving the rack and the carriage relative to one another using the thrust motor to position the horizontal directional drilling machine in each of the first, second, and third positions using the saved rack encoder signal values and float signal values.

Various embodiments of a horizontal directional drilling machine comprise a rack frame, a carriage longitudinally movable along the rack frame, a mechanical arrangement coupled to the carriage and the rack frame, the mechanical arrangement controlling relative movement between the carriage and the rack frame, a thrust motor coupled to the carriage such that thrust or pullback output from the thrust motor moves the carriage relative to the rack, a gearbox mounted on the carriage, the gearbox longitudinally movable along the carriage, the gearbox comprising a rotation motor, a spindle attached to the gearbox, the spindle rotatable by the rotation motor and having a distal end coupling, the distal end coupling configured to attach to the proximal end of a drill rod, a vise assembly mounted on the rack frame, the vise assembly comprising a proximal vise linearly and rotationally moveable with respect to the rack frame, the proximal vise comprising a clamping mechanism configured to secure the drill rod by clamping onto the drill rod, a rotation encoder sensor configured to output a rotation encoder signal indicative of rotation of the spindle, a rack encoder sensor configured to output a rack encoder signal indicative of relative movement between the carriage and the rack, a float sensor configured to output a float signal indicative of relative movement between the carriage and the gearbox, means for determining the relative positioning of the spindle relative to the proximal vise based on the rack encoder signal and the float signal, means for positioning the drill rod within the proximal vise using the determined relative positioning of the spindle and the thrust motor, means for determining a state of threaded coupling between the drill rod and a drill string based on the rotation encoder signal and the float signal, and means for rotating the drill rod using the spindle rotated by the rotation motor based on the determined state of the threaded coupling.

Such an embodiment may further comprise means for applying a force between the gearbox and the carriage that pushes the gearbox in the distal direction relative to the carriage, and means for changing the output of the thrust motor based in part on the position of the gearbox along the carriage as indicated by the float signal.

Such an embodiment may further comprise means for increasing thrust motor output when the float signal indicates that the gearbox is in a first position relative to the carriage, and means for reducing thrust motor output when the float signal indicates that the gearbox is in a second position relative to the carriage, wherein the first position is distal of the second position with respect to the carriage.

Such an embodiment may further comprise means for determining the number of turns the distal end coupling is threaded into the proximal end of the drill rod by counting the number of revolutions of the spindle as indicated by the rotation encoder sensor when the float signal indicates that the gearbox has moved proximally with respect to the carriage after a change in output by the thrust motor.

Such an embodiment may further comprise means for decreasing output by the thrust motor based on the determined number of turns the distal end coupling is threaded into the proximal end approaching a predetermined value, the predetermined value based on the quantity of threading in the proximal end of the drill rod.

While the invention will be described with respect to preferred embodiment configurations and with respect to particular devices used therein, it will be understood that the invention is not to be construed as limited in any manner by either such configuration or components described herein. Also, while particular methods of measuring and specific stop locations are described herein, it will be understood that such particular measurements and stop locations are not to be construed in a limiting manner. Instead, the principles of this invention extend to any manner of measuring carriage location on a rack and controlled movement as the carriage nears a predetermined stop location. These and other variations of the invention will become apparent to those skilled in the art upon a more detailed description of the invention.

For a better understanding of the invention, however, reference should be had to the drawings which form a part hereof and to the accompanying descriptive matter, in which there is illustrated and described a preferred embodiment of the invention.

### BRIEF DESCRIPTION OF THE DRAWINGS

FIG. 1 is an elevated side plan view illustrating components of a horizontal directional drilling device in accordance with embodiments of the invention;

FIGS. 2A-2B are schematic cross-section views along the longitudinal axis of the horizontal directional drilling device;

FIG. 3 is an elevated side plan view illustrating components of the horizontal directional drilling device;

FIG. 4 is a schematic side view of a portion of the horizontal directional drilling device; and

FIG. 5 is an illustration of the location of the rack and gearbox of the horizontal directional drilling device during the rod breakout process;

FIGS. 6A-C are graphic views of the display of the horizontal directional drilling device showing the carriage at three different positions along the rack; and

FIG. 7 is a block diagram of control circuitry of the horizontal directional drilling device.

While the invention is amenable to various modifications and alternative forms, specifics thereof have been shown by way of example in the drawings and will be described in detail herein. It is to be understood, however, that the intention is not to limit the invention to the particular embodiments described. On the contrary, the invention is intended to cover all modifications, equivalents, and alternatives falling within the scope of the invention as defined by the appended claims.

### DETAILED DESCRIPTION

In the following description of the illustrated embodiments, references are made to the accompanying drawings forming a part hereof, and in which are shown by way of illustration, various embodiments by which the invention may be practiced. It is to be understood that other embodiments may be utilized, and structural and functional changes may be made without departing from the scope of the present invention.

Systems, devices or methods according to the present invention may include one or more of the features, structures, methods, or combinations thereof described herein. For example, a HDD system may be implemented to include one or more of the advantageous features and/or processes described below. It is intended that such a system need not include all of the features described herein, but may be implemented to include selected features that provide for useful structures and/or functionality.

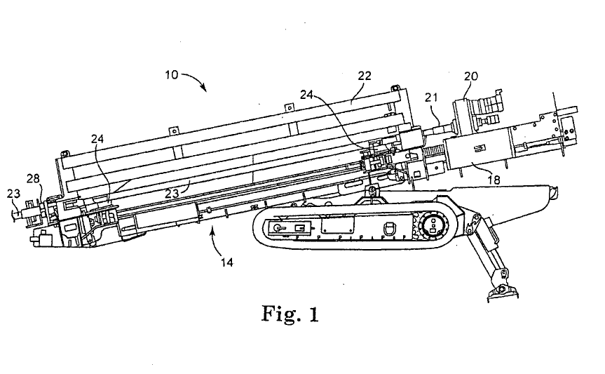

FIG. 1 illustrates a horizontal directional drill 10 including a main frame 14, a rack frame 18, a gearbox 20 on a carriage 40 that is arranged and configured to move back and forth along the longitudinal axis of the rack frame 18. Spindle 21 can be independently rotated clockwise or counterclockwise. A rod magazine 22 located generally above and to the side of the rack frame stores drill rods. A pipe transfer mechanism 24 is arranged and configured to move the drill rod from the magazine 22 to a position in line with the drill string 23. A vise assembly 28 is located at the lower, opposing end of the horizontal directional drill 10 from the gearbox 20. Accordingly, in operation, the pipe transfer mechanism 24 supports and transfers individual drill rods from the magazine 22 and into alignment with the drill string 23 and spindle 21 of gearbox 20.

While not specifically shown, it will be appreciated that an operator console, controls, and a prime mover are also included as part of the horizontal directional drill 10, as well as other components that operate in their recognized manner. It will also be appreciated that as used herein, drill rod is referred to as both drill rod and drill pipe. Such terms are used interchangeably and are not meant to denote a different type of work piece or structure. Still further, as used herein, the term lower refers to a position closer/nearer to the surface of the ground, while upper refers to a position that is relatively further from the ground.

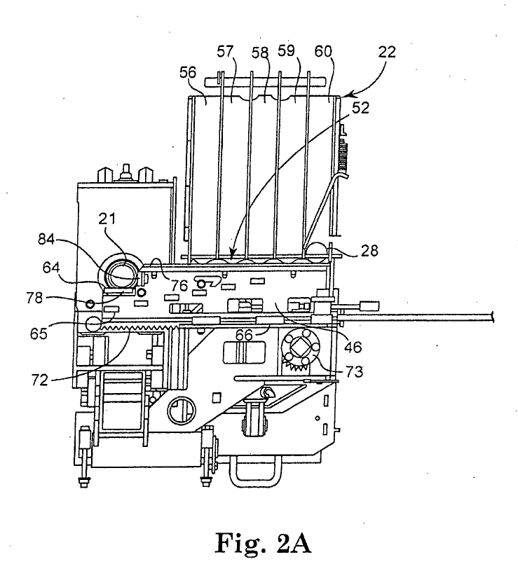

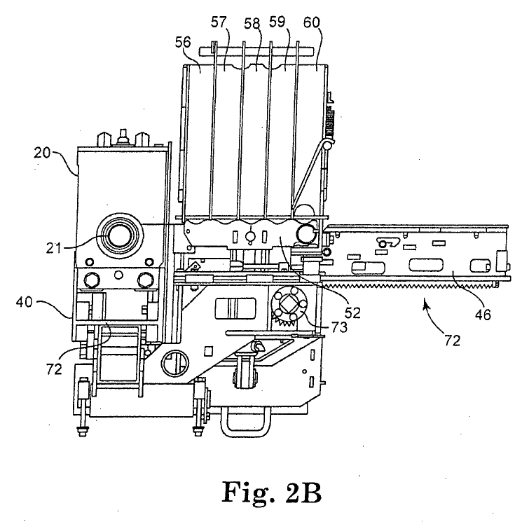

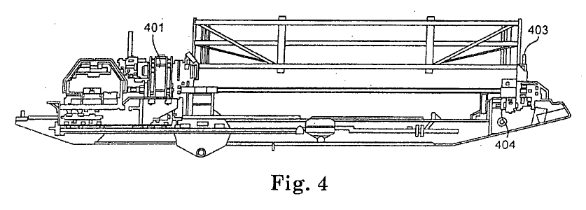

In FIGS. 2A-2B, only one of the pipe transfer members 46 is shown. The illustrated pipe transfer member 46 includes a pipe receiving region 64 positioned at an end 65 of the pipe transfer member that is closest or proximal to the drill string. When the pipe transfer member 46 is in the retracted orientation of FIG. 2b, the pipe receiving region 64 is preferably located beneath the magazine 22 (e.g., directly beneath a selected one of the magazine storage columns and associated discharge opening). By contrast, when the pipe transfer member 46 is in the extended orientation of FIG. 4a, the pipe receiving region 64 is positioned at the drive axis of the drill string 23. As so positioned, a pipe held within the pipe receiving region 64 is preferably placed in coaxial alignment with the drill string 23 axis.

The pipe transfer member 46 is slidably mounted on a lower track 66. A gear rack 72 is secured to the bottom of the pipe transfer member 46. The gear rack 72 fits within an elongated slot defined by the track 66. The rack 72 cooperates with a drive gear 73, such as a pinion gear driven by a hydraulic motor, to move the pipe transfer member 46 between the extended and retracted orientations.

Referring still to FIGS. 2A-2B, the pipe transfer member 46 includes a top pipe retaining surface 76 that is used to block the discharge openings. The retaining surface 76 prevents pipes from being discharged from the columns 56-60 when such columns contain pipes, and the pipe receiving region 64 of the pipe transfer member 46 is not positioned below a selected one of the columns 57-60. The pipe transfer member 46 also includes a lower platform 78 that is recessed relative to the pipe retaining surface 76. Both the lower platform 78 and the pipe retaining surface 76 are covered by wear strips preferably made of a suitable plastic-type material.

With the pipe aligned with the drill string 23 axis, the spindle 21 of the drive head 20 can be threaded into the pipe, and the pipe can be drilled into the ground. To do this, the carriage 40 moves between the vise end of the rack (or lower end of the rack) and the opposite end of the rack (or upper end of the rack). During this operation, thrust outputs are employed to move the carriage 40 along the rack. The movement may be described as moving from a position proximal to the vise 28 to a position distal to the vise 28. As used herein, proximal is used to refer to positioning or direction away from a bore hole (toward the upper end of the rack/frame and away from the lower end) and distal is used to refer to positioning or direction closer to a bore hole (toward the lower end of the rack/frame and away from the upper end).

The carriage 40 may be described as including a vise end. As used herein, the vise end of the carriage 40 is that portion of the carriage which faces the vise 28 as the carriage moves back and forth on the rack. After pushing the drill string into the ground, the carriage is returned to the position distal to the vise 28 so that another drill pipe can be connected to the drill string. The carriage 40 may be slideably mounted on a plate 41 for movement along the rack.

During a backreaming operation, the carriage 40 moves from a position proximate to the vise 28 to a position distal to the vise 28. A drill rod is then removed from the drill string, and the carriage is returned to a location proximate the vise 28. During this operation, pullback outputs are employed to move the carriage along the rack. For rack distance sensing, the rack distance is preferably measured with an absolute encoder (or other position sensor) to input the distance between the vise end of the rack and the vise end of the carriage. When the carriage is touching the vise stop the rack distance=0. As the carriage moves away from the vise 28, the rack distance increases, which is monitored by the encoder and this information concerning the movement is relayed to a control circuit.

Conventional horizontal directional drilling (HDD) requires at least one human operator controlling operation of the drill rig, such as conducting operations for adding and removing drill string rods, among other actions. Even though advanced mechanical systems have aided drill operations, an operator is still required to monitor drilling operations via gauges, make eyeball estimates of the speeds and distances of rig components relative to one another (e.g., carriage, vises, rods), and manually control the motor input animating these components. Each human operator must use his or her technique and expertise to determine how to make-up and break-out drill string rods in a HDD rig.

Different procedures, velocities, and machine stresses can be used to provide a great variety of different make-up and break-out options available to a drill operator. Therefore, a competent drill rig operator must be knowledgeable in not only how to make-up and break-out drill string rods, but also take care that appropriate speeds and stresses are employed to efficiently and safely perform make-up and break-out procedures without undue wear and tear on the machine. The result is that proper HDD requires at least one highly skilled human operator actively monitoring the HDD operations at all times to manage the addition and removal of drill string rods. The attention required by a highly skilled human HDD operator substantially increases drilling costs, and can distract from other important HDD operations, such as active obstacle detection. Moreover, a skilled HDD rig operator may not always be able to slow down the motor driven components via manual control in a manner to efficiently and safely manage the addition and removal of drill string rods without undue wear and tear on the machine. For example, an operator may visually estimate (“eye-ball”) the positioning and velocity of a carriage, gearbox, and drill rod as they are advanced forward toward the vise by a thrust motor as controlled manually by the operator. If the operator does not advance (or retract) the drill rod slowly enough then the operator risks the carriage, gearbox, or other component in motion ramming into parts of the rig. If an operator is especially careful in adjusting the motors to move the components slowly then the operator may take more time than necessary in making-up or breaking-out each drill rod from the drill string, delaying completion of the project.

Apparatuses and methods of the present invention address many of the complications encountered in conventional HDD procedures. For example, apparatuses and methods of the present invention can provide a network of sensors for determining the relative positioning of critical rig components and managing motion between them for fast and safe drill string rod management. In some embodiments, the addition and/or removal of drill rods is done automatically with no human intervention, facilitated by a processor executing program instructions stored in memory. However, in some embodiments of the invention, a human operator is helped in managing the addition and/or remove of drill string rods by the information provided by the network of sensors.

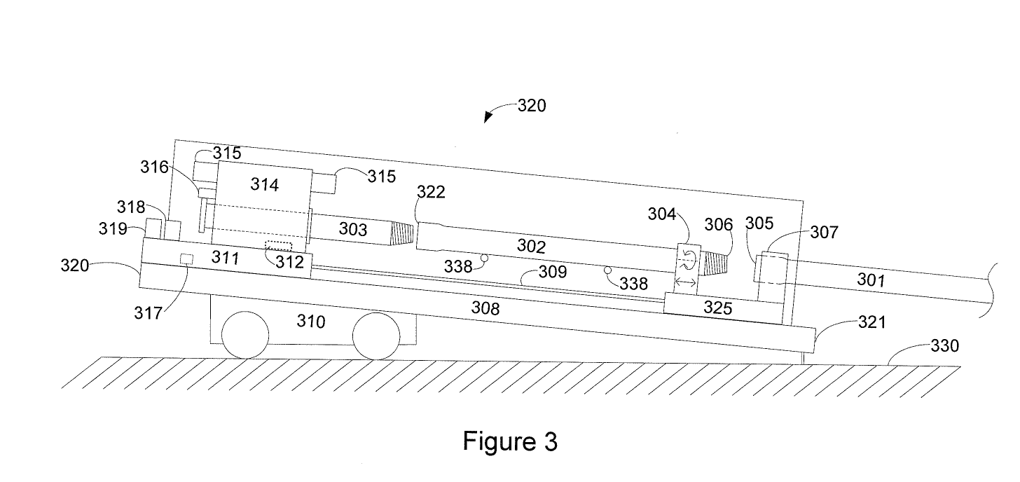

FIG. 3 illustrates a drill rig 320 that can embody, and carry out, aspects of the present invention. Drill rig 320 includes a base 310 having tires for transporting the drill rig 320. The base 310 can tilt the drill rig 320 such that the distal end 321 of the drill rig 320 is lower to the ground 330 relative to the proximal end 320 and the distal end 321 points into the ground 330.

A drill string 301 extends distally from the distal end 321 of the drill rig 320 into a bore hole (not shown). Drill string 301 is composed of multiple drill rods, such as drill rod 302 within the drill rig 320. Drill rods generally have a coupling mechanism at each proximal and distal ends so that the rods can be attached end-to-end. The drill string 301 length can be extended as needed by adding rods or reduced in length by removing rods from the drill string 301. Some drill rods have male and female type couplings to attach the rods end-to-end. The particular drill string 301 illustrated is composed of rods secured together by the mating of threading. The drill rod 302 includes outer threading on the distal end 306 and corresponding inner threading in a cavity on the proximal end 322 of the drill rod 302. The outer threading of a rod can be threaded (screwed) into the inner threading on the inner cavity surface on the proximal end of each rod to secure the rods together.

The base 310 supports a frame 308, which supports the remaining components of the drill rig 320. For example, a vise assembly 325 is rigidly attached to the frame 308. The vise assembly 325 includes a distal vise 307 and a proximal vise 304. Each of the vises 304 and 307 can clamp onto and secure a drill rod, including the drill rod 302 within the drill rig 320 and the proximal end 305 of the most proximal drill rod of the drill string 301. In this particular embodiment, the distal vise 307 is rigidly attached to the vise assembly 325 while the proximal vise 304 can rotate about the longitudinal axis of the drill rod 302 and translate proximally and distally with respect to the distal vise 325 (and therefore can also translate proximally and distally with respect to other components rigidly attached to, other otherwise made stationary with respect to, the frame 308, for example). The rotation and longitudinal translation of the proximal vise 304 can be controlled by an electromechanical mechanism or motor, for example.

Carriage 311 is mounted on the frame 308 in a manner that allows the carriage 311 to translate proximally and distally with respect to the frame 308. The carriage 311 may be guided in sliding along the frame 308 by one or more cylinders and/or it may slide along a track in the frame 308. Movement of the carriage 311 along the rack 308 can be governed by a mechanical arrangement, such as a rack and pinion arrangement 309.

Several motors are supported by the carriage 311, including the thrust motor 319 and pull back motor 318. A rack encoder sensor 317 is mounted on either the carriage 311 or frame 308 and tracks the relative positioning and/or movement between the carriage 311 and the frame 308. For example, as the carriage 311 slides distally with respect to the frame 308 the rack encoder sensor 317 may read a series or markings indicating relative positioning and/or movement. In some embodiments, greater number of markings that pass the rack encoder sensor 317 indicate greater relative translation. Also, the rate at which the markings are sensed provides an indication of the velocity of relative translation. Likewise, acceleration of the carriage 311 relative to the frame 308 can be determined using these methods. Although a encoder sensor is described herein, other sensor systems having comparable capabilities to determine relative translation between, for example, the carriage 311 and the rack 308 are also contemplated herein.

Output from the thrust motor 319 and the pull back motor 318 can apply force to move the carriage 311 relative to the rack 308. For example, the thrust motor 319 can apply force to push the carriage 311 distally with respect to the frame 308. To the extent that the base 310 stabilizes the drill rig 320, the thrust motor 319 can move the carriage 311 distally which can similarly move components of the drill rig 320 supported by the carriage, such as the gearbox 314 and the spindle 303 attached to the gearbox 314. Distal advancement of the spindle 314 (by way of the gearbox 314, carriage 311, and thrust motor 319) can advance the drill rod 302 and drill string 301 distally and into a bore hole. Likewise, pull back motor 318 can apply a reverse force to move the carriage 311 proximally, moving the gearbox 314, spindle 303, drill rod 302, and drill string 301 proximally as well. As referenced above, the rack encoder sensor 317 can monitor such movement and provide feedback control signals indicating location, velocity, acceleration, relative positioning, and progress to motors, such as thrust and pull back motors 319 and 318, and/or control circuitry.

Gearbox 314 includes a rotation motor 315 which can rotate the spindle 303. Rotation of the spindle 303 can be monitored by the rotation encoder sensor 316. The rotation encoder sensor 316 can track rotation of the spindle 303 by sensing markings that pass by the rotation encoder sensor 316. Each rotation of the spindle 303 can correspond to a number of markings on the spindle 303 in a circumferential array. A small number of markings can then correspond to a quarter turn or a number of degrees of rotation, for example. The rate that the rotation encoder sensor 316 senses markings pass by the sensor can indicate rotation rate (e.g., # rotations/minute) of the spindle 303.

Gearbox 314 is mounted on the carriage 311 such that it can translate proximally and distally with respect to the carriage 311. In some embodiments, the mechanism such as pressurized cylinders or springs are used to apply a force to the gearbox 314 relative to the carriage 311 to make the gearbox 314 move to its distal most position relative to the carriage 311. In some embodiments, the gearbox 314 does not rely on a artificially provided force, but is pulled distally with respect to the carriage 311 by gravity when the drill rig 320 is tilted, as illustrated. In some embodiments, the gearbox 314 can slide distally, due to gravity, relative to the carriage 311 because the carriage 311 is inhibited in movement by a rack and pinion mechanism 309 that only allows the carriage 311 to move under force by the thrust and pull back motors 319 and 318.

A float sensor 312 can be used to sense the relative positioning and/or movement between the gearbox 314 and the carriage 311. The float sensor 312 may be an absolute encoder sensor which monitors the relationship between the gearbox 314 and the carriage 311 by sensing markings on the gearbox 314 or carriage 311 that pass by the float sensor 312 in the same manner as the rack encoder 317 to determine relative positioning and movement.

Embodiments of the invention can be used to automatically add and remove drill rods from a drill string, the automatic drill rod addition and removal facilitated by a network of sensors. For example, a drill rod 302 can be added to a drill string 301 by a series of coordinated actions guided by rack encoder sensor 317, rotation encoder sensor 316, and float sensor 312. Mechanical arms 338 can remove a drill rod 302 from a magazine and support the drill rod 302 in line with the spindle 303 and drill string 301. Once in place, the mechanical arms 338 and/or proximal vise 304 can be moved such that a distal portion of the drill rod 302 is within the proximal vise 304. The proximal vise 304 can then clamp onto the distal portion of the drill rod 302 and secure the drill rod 302 relative to the spindle 303 and the drill string 301.

Once the drill pipe 302 is secured by the proximal vise 304, the rotation motor 315 can rotate (e.g., clockwise) the spindle 303 and the thrust motor 319 can move the carriage 311 distally such that the spindle 303 approaches and engages the proximal end 322 of the drill rod 302. The motion of the spindle 303 relative to the proximal end 322 of the drill rod 302 engages the threading of the spindle 303 and the proximal end 322 of the drill rod 302. As the spindle 303 engages the drill rod 302, pushback from the drill rod 302 will likely be experienced, as the drill rod 302 is held in place by the proximal vise 304 as the spindle 302 is advanced. Because the thrust motor 319 accelerates the carriage 311, and not the gearbox 314 directly (but rather indirectly through the mechanism between the carriage 311 and the gearbox 314), the gearbox 314 can be pushed proximally with respect to the carriage 311 by the pushback from the spindle 303/drill rod 302 engagement.

When the gearbox 314 is at the most distal position with respect to the carriage 311 then there is a “no float” condition (e.g., 0% float) as sensed by the float sensor 312, meaning that no force is pushing the gearbox 314 proximally to counteract gravity or any other mechanism that may be pushing the gearbox distally with respect to the carriage 311. The gearbox 314 can be pushed to a proximal most position with respect to the carriage 311 indicating significant pushback and therefore maximum float (e.g., 100% float). In various embodiments it is desirable to moderate the thrust motor 319 and/or pull back motor 318 to maintain some level of float (e.g., 25-75%) as indicated by the float sensor 312 when the spindle 303 is translating.

This relative motion between the carriage 311 and the gearbox 314 can be sensed by the float sensor 312, which can be used to indicate that the threaded coupling mechanism on the distal end of the spindle 303 has engaged the proximal end 322 of the drill rod 302 and that each rotation of the spindle 303 likely screws the threading of the spindle 303 into the drill rod 302 one rotation as long as the spindle is rotating 303 as monitored by the rotation encoder sensor 316. If pushback was not sensed by the float sensor 312 then revolutions of the spindle 303 likely do not screw the threads of the spindle 303 and the drill rod 302 together. Therefore, by starting the counting of revolutions only after some predetermined amount of pushback is sensed through the float sensor 312 by way of carriage 311/gearbox 314 relative movement, an accurate counting can be made of the number of turns the spindle 303 coupling has been screwed into the threading of the drill rod 302. Knowing the total number of revolutions the outer threading is threaded into inner threading can allow the rotation motor 315 to screw thread couplings together at a high rate and slow down the rotation rate when a predetermined amount of threading is complete (e.g., when 75% of the total number of threads is complete). Without such an automated accurate way to determine the number of threads completed, a human operator would need to make an eyeball estimate and prematurely slow down the revolutions. Moreover, if the spindle 303 is not appropriately slowed down, than damaging stresses can be experienced in the drilling rig 320 and in drilling rod couplings when the total number of couplings are completed and the rod 302 and/or spindle 303 will no longer rotate with respect to another rod or the drill string 301 (e.g., overshooting the number of threads and continuing to spin the spindle 303 despite all thread joints being completed).

While screw couplings are being made or broken (e.g., between spindle 303 and drill rod 302 and/or drill rod 302 and drill string 301) it can be desirable to maintain a certain range of float, using the thrust and pull back motors 319 and 318 to adjust the float level by using the float sensor 312 as a feedback loop. For example, high levels of float (e.g., above 75%) can signal too much push back and thereby indicate too much machine stress caused by excessive thrust motor 319 thrusting. Low levels of float (e.g., below 25%) can signal too little push back and thereby indicate inefficient operation and that a more aggressive approach (e.g., higher thrust motor 319 thrusting) could result in greater productivity and efficiency. Therefore, if the float sensor 312 indicates high levels of float then thrust motor 319 output or pull back motor 318 output can be reduced. If the float sensor 312 indicates low levels of float then thrust motor 319 output or pull back motor 318 output can be increased. If the float sensor 312 indicates appropriate levels of float (e.g., 25-75%) then thrust motor 319 output or pull back motor 318 output can maintain current output levels until some indication is received that the operation is complete or nearing completion (e.g., counting of thread rotation indicates that threading is almost complete for a drill rod joint).

Once the spindle 303 is secured to the drill rod 302 the proximal vise 304 can release the drill rod 302. The thrust motor 319 can then advance the drill rod 302 to engage the drill string 301. Rack encoder 317 can be used to track distal advancement of the drill string and accelerate/decelerate the drill rod 302 depending on the distance of the carriage to the zero point at its forward must position. As before, rotation motor 315 can rotate the spindle 303 thereby rotating the drill rod 302. When pushback is sensed by relative movement between the carriage 311 and the gearbox 314 then the rotation encoder sensor 316 can start counting the number of revolutions corresponding to the number of turns the threading on the distal end 306 of the drill rod 302 is threaded into the inner threads of the proximal end 305 of the drill string 301, in the manner described above (e.g., start counting revolutions when a certain amount of float is sensed). During this procedure, the float can be monitored and pull back motor 318 and/or thrust motor 319 output can be adjusted to maintain efficiency and machine stress. Rotation motor 315 output can be tapered as the number of revolutions of completed threads approaches the number of threads understood to be in a drill rod joint (e.g., a number of threads saved in memory, the number corresponding to a known number of threads for the particular type of drill rod being used). When the drill rod 302 is completely screwed into the drill string 301, then the distal vise 307 can unclamp and boring can be continued.

The network of sensors can also be used to automate removal of drill rods from a drill string. For example, the drill string 301 can be pulled back using the pull back motor 318 to place the proximal end 307 of the drill string 301 and the distal end 306 of the drill rod 302 to a first predetermined relationship position with respect to the vise assembly 325, the proximal vise 304, and/or the distal vise 305. The rack encoder sensor 317 can sense relative movement of the carriage 311 with respect to the vise assembly 325 to determine when the first predetermined relationship position has been reached, and can further provide a feedback signal to control circuitry and/or motors 318 and 319 to automatically guide the drill rig 320 to assume this position.

When in the first predetermined relationship position, the proximal vise 304 can clamp onto the drill rod 302 and the distal vise 307 can clamp onto the drill string 301, securing the drill rod 302 and the drill string 301. Once secure, the proximal vise 304 can rotate the drill rod 302 relative to the drill string 301 to loosen the threads coupling the drill rod 302 and the drill string 301. In some embodiments, only a quarter turn between the drill rod 302 and the drill string 301 is necessary to loosen this joint relative to the joint between the spindle 303 and the drill rod 302.

After the proximal vise 304 rotates, the proximal vise 304 can unclamp the drill rod 302. The rotation motor 315 can then rotate the drill rod 302 through the spindle 303 to unscrew the drill rod 302 from the drill string 301. Because the joint between the drill rod 302 and the drill string 301 was previously isolated and rotated by the vises 304 and 307 to loosen this joint, the joint should be unscrewed by the spindle 303 rotation before the threaded joint between the spindle 303 and drill rod 302 is unscrewed. During the unscrewing procedure the gearbox 314 can be pushed distally because the joints are expanding lengthwise due to being unscrewed. The float sensor 312 can measure this change pushback and therefore determine the progress and completion of the unscrewing procedure, depending on the length of the threaded portions and the mount of the pushback. In this way, a float sensor 312 signal can indicate the progress of decoupling the threaded joint and provide feedback control to a controller and/or rotation motor 315 and pull back motor 318 to automatically manage unthreading this and other joints, including accelerating and decelerating the spindle 303 with the rotation motor 315 based on threading/unthreading progress.

After the unthreading of the drill string 301 from the drill rod 302 has been completed, the relative position of the drill string 302 and the proximal vise 304 can be determined using the rack encoder sensor 317 output and the float sensor 312 output. The information concerning this relative positioning can be used to provide controls to the proximal vise 304, the thrust motor 319, and the pull back motor 318 to automatically move the drill rod 302 relative to the proximal vise 304 and align them in a second position where the proximal vise 304 is over the drill rod 302 but not over the outer threading on the distal end 306 of the drill rod 302 and the threading on the distal end 306 of the drill rod 302 is clear from the proximal end 305 of the drill string 301. When the second position is reached, the proximal vise can then clamp onto the drill rod 302.

In the second position, the rotation motor 315 can rotate the spindle 303 to unthread the spindle 303 from the proximal end 322 of the drill rod. While the spindle 303 is rotating the rotation encoder 316 can measure the number and rate of revolutions of the spindle 303 to track progress of the unthreading. The rotation encoder 316 information concerning unthreading progress can be used to control the rotation motor 315 output. When the spindle 303 is unthreaded from the drill rod 302, the carriage 311 can be moved proximally by the pull back motor 318 to have the drill rig 320 assume a third predetermined position, as guided by information concerning relative positioning from the rack encoder sensor 317 and float sensor 312. In the third position, the spindle 303 is moved proximally to allow sufficient clearance between the spindle 303 and the drill rod 302 so that the drill rod 302 can be lifted up by arms 338 and moved into a drill rod magazine.

The first, second, and third positions can be calibrated and rack encoder sensor 317 and float sensor 312 signals can be saved in memory to facilitate controlling output of the thrust and pullback motors 319 and 318 so that the components of the drill rig 320 can be guided to assume these positions as discussed herein. For example, in a factory or other setting, a technician can manually place the components of the drill rig 320 in the appropriate positions for each of the first, second, and third positions while a drill rod 302 is in place. For example, when manually placed in the third position described above, the technician can ensure that there is appropriate clearance between the threads so that thread damage does not occur when the drill rod 302 is lifted out. Moreover, each of the components can be run through all ranges (e.g., carriage 311 at the distal most position then at the proximal most position) while the sensors monitor relative movement and positioning to calibrate the system.

FIG. 4 illustrates first, second, and third positions as described herein that can be used to facilitate automatic make-up and break-out drill rig operations. Gearbox and carriage centers the drill stem in vises at position 1 (403). Carriage movement translates the drill stem backwards to position 2 (404). Gearbox and carriage can then be moved to position 3 (401) to clear drill stem.

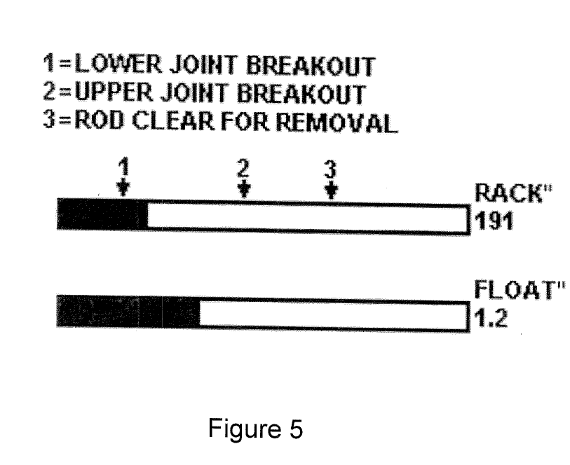

FIG. 5 illustrates a display reflecting data collected by float and rack encoder sensors with markings for the first, second, and third positions. Such a display allows an operator to monitor the relative positioning of drill rig components and override and/or guide the components (e.g., carriage, gearbox) using manual control and viewing the display. These first, second, and third positions can correspond to the first, second, and third positions discussed above for make-up and break-out procedures.

For controlling the carriage movement as shown in FIG. 2B, and more specifically to slow-down the carriage 40 as it nears the vise 28 or the distal end, the thrust and pullback outputs, respectively, are modified in accordance with the distance sensed by the sensors discussed herein, such as the distance between a spindle and a drill rod or between a vise and the carriage sensed by a rack encoder and/or float sensor. For example, as the carriage 40 approaches either end of the rack 18 the thrust/pullback outputs are reduced to slow the carriage speed. The reduction may be proportional (or in some other controlled movement). This decelerates the carriage linearly down to an adjustable slow-down speed. When the carriage 40 reaches the zero distance (Front STOP) the thrust output is turned off. When the carriage 40 reaches the maximum rack distance (e.g., at the distal end of the rack from the vise)(Rear STOP), the pullback output is turned off.

Controlled movement may be performed at other predetermined locations on the rack. Further, adjustments to thrust/pullback outputs may be performed at designated or other predetermined locations.

An operator can control front and rear vise, thrust/pullback, and rotation outputs to break out or make up rods as they are pushed into or pulled out of the ground.

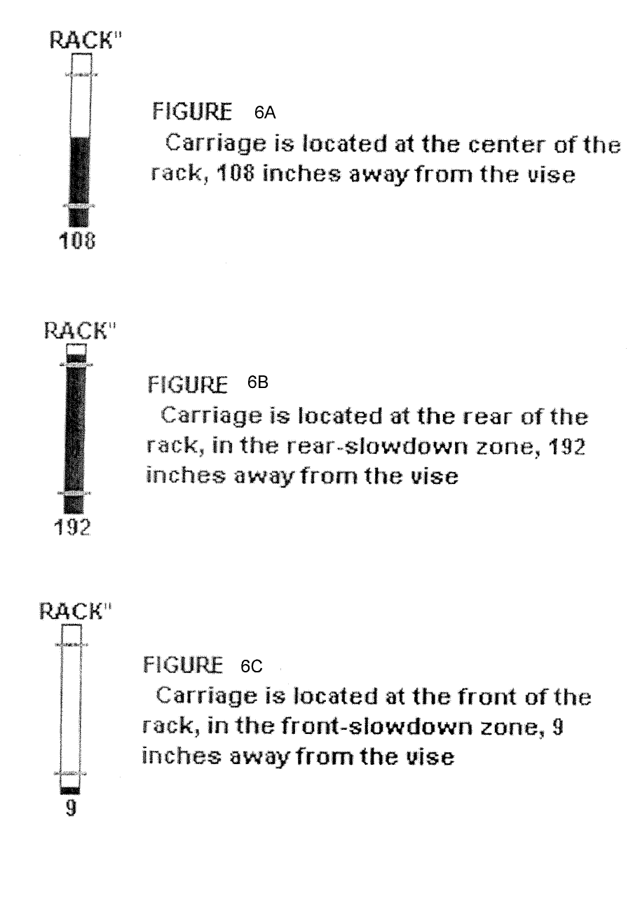

A rack distance indicator display is illustrated in FIGS. 6A-6C. Preferably, the rack distance indicator is displayed at the operator console in a visually perceptible manner. For example a multi-function display may be utilized. The information reflected in the rack distance indicator is generated based on the rack encoder and/or float sensor in the manner referenced herein.

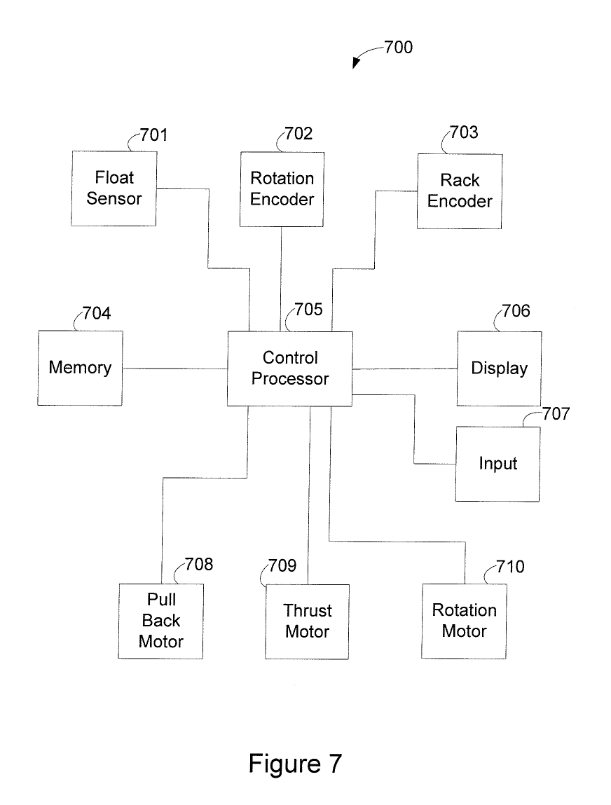

FIG. 7 illustrates control circuitry 700 that can be used in embodiments of the present invention. Each of the float sensor 701, rotation encoder 702, and rack encoder 703 can output signals to the control processor 705 as described herein to indicate positioning and movement information.

A user interface including display 706 and input 707 provides for interaction between an operator and the HDD machine. The display 706 and input 707 includes various manually-operable controls, gauges, readouts, and displays to effect communication of information and instructions between the operator and the HDD machine.

The user interface may include a display 706, such as a liquid crystal display (LCD) or active matrix display, alphanumeric display or cathode ray tube-type display (e.g., emissive display), for example.

Each of the pull back motor 708, thrust motor 709, and rotation motor 710 are in communication with the central processor 705. The central processor 705 can receive signals from the sensors 701-703 and control output of the motors 708-710 in a feedback loop, as described herein.

Embodiments of the invention can use memory 704 coupled to the control processor 705 to perform the methods and functions described here. Memory can be a computer readable medium encoded with a computer program, software, computer executable instructions, instructions capable of being executed by a computer, etc, to be executed by circuitry, such as central processor and/or machine controller. For example, memory can be a computer readable medium storing a computer program, execution of the computer program by central processor causing reception of one or more signals from sensors, measurement of the signals, calculation using one or more algorithms, and outputting of control signals to the pull back motor 708, thrust motor 709, and rotation motor 710, according to the various methods and techniques referenced by the present disclosure.

Control circuitry 700 can be used to animate a drill rig (e.g., 320) as described in the following steps:

### Rod Breakout Sequence:

Step 1=Operator initiates the Auto Rod-Breakout Sequence while the carriage is at the rear of the rack
Step 2=Auto Breakout starts by positioning the Carriage on point 1 of the Rack Indicator
Step 3=Auto Breakout clamps the front vise
Step 4=Auto Breakout rotates the drill stem CCW a specified # of turns, breaking the front joint
Step 5=Auto Breakout positions the Carriage on point 2 of the Rack Indicator
Step 6=Auto Breakout clamps the rear vise
Step 7=Auto Breakout rotates the drill stem CCW a specified # of turns, breaking the rear joint
Step 8=Auto Breakout positions the Carriage on point 3 of the Rack Indicator Auto Breakout is complete; the operator returns the rod to the rod box

### Rod Makeup Sequence:

Step 1=Operator initiates the Auto Rod-Makeup Sequence while the carriage is at the rear of the rack
Step 2=Auto Makeup starts by thrusting the Carriage to point 2 of the Rack Indicator
Step 3=Auto Makeup Clamps the rear vise
Step 4=Auto Makeup thrusts the Carriage until a specified amount of GB float has been achieved
Step 5=Auto Makeup Rotates a specified # of turns at 100% speed, making up the rear joint
Step 6=Auto Makeup Rotates at 50% speed until the specified Makeup Pressure is reached
Step 7=Auto Makeup Un-Clamps the rear vise
Step 8=Auto Makeup thrust the Carriage to point 1 of the Rack Indicator (See FIG. 2)
Step 9=Auto Makeup Clamps the front vise
Step 10=Auto Makeup thrust the Carriage until a specified amount of GB float has been achieved
Step 11=Auto Makeup Rotates a specified # of turns at 100% speed, making up the front joint
Step 12=Auto Makeup Rotates at 50% speed until the specified Makeup Pressure is reached
Step 13=Auto Makeup Un-Clamps the front vise
Auto Makeup is complete

The discussion and illustrations provided herein are presented in an exemplary format, wherein selected embodiments are described and illustrated to present the various aspects of the present invention. Systems, devices, or methods according to the present invention may include one or more of the features, structures, methods, or combinations thereof described herein. For example, a device or system may be implemented to include one or more of the advantageous features and/or processes described below. A device or system according to the present invention may be implemented to include multiple features and/or aspects illustrated and/or discussed in separate examples and/or illustrations. It is intended that such a device or system need not include all of the features described herein, but may be implemented to include selected features that provide for useful structures, systems, and/or functionality.

Although only examples of certain functions may be described as being performed by circuitry for the sake of brevity, any of the functions, methods, and techniques can be performed using circuitry and methods described herein, as would be understood by one of ordinary skill in the art.

While particular embodiments of the invention have been described with respect to its application, it will be understood by those skilled in the art that the invention is not limited by such application or embodiment or the particular components disclosed and described herein. It will be appreciated by those skilled in the art that other components that embody the principles of this invention and other applications therefore other than as described herein can be configured within the spirit and intent of this invention. The arrangement described herein is provided as only one example of an embodiment that incorporates and practices the principles of this invention. Other modifications and alterations are well within the knowledge of those skilled in the art.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A horizontal directional drilling machine, comprising:
a rack frame;
a carriage longitudinally movable along the rack frame;
a mechanical arrangement coupled to the carriage and the rack frame, the mechanical arrangement controlling relative movement between the carriage and the rack frame;
a thrust motor coupled to the carriage such that thrust or pullback output from the thrust motor moves the carriage relative to the rack frame;
a gearbox mounted on the carriage, the gearbox longitudinally translatable along the carriage, the gearbox comprising a rotation motor;
a spindle attached to the gearbox, the spindle rotatable by the rotation motor and having a distal end coupling, the distal end coupling configured to attach to the proximal end of a drill rod;
a vise assembly mounted on the rack frame, the vise assembly comprising a proximal vise linearly and rotationally moveable with respect to the rack frame, the proximal vise comprising a clamping mechanism configured to secure the drill rod by clamping onto the drill rod;
a rotation encoder sensor configured to output a rotation encoder signal indicative of rotation of the spindle;
a rack encoder sensor configured to output a rack encoder signal indicative of relative movement between the carriage and the rack frame;
a float sensor configured to output a float signal indicative of relative movement between the carriage and the gearbox; and
control circuitry comprising a processor and memory, the processor configured to execute program instructions stored in memory, processor execution of the stored program instructions causing the control circuitry to determine the relative positioning of the gearbox relative to the proximal vise based on the rack encoder signal and the float signal, position the drill rod within the proximal vise using the determined relative positioning of the gearbox and the thrust motor, determine a state of threaded coupling between the drill rod and a drill string based on the rotation encoder signal and the float signal, and rotate the drill rod using the spindle rotated by the rotation motor based on the determined state of the threaded coupling.

2. The horizontal direction drilling machine of claim 1, further comprising a mechanical arrangement that applies a force between the gearbox and the carriage, the mechanical arrangement pushing the gearbox in the distal direction relative to the carriage using the force, wherein processor execution of the stored program instructions causes the control circuitry to change the output of the thrust motor based in part on the position of the gearbox along the carriage as indicated by the float signal.

3. The horizontal direction drilling machine of claim 2, wherein processor execution of the stored program instructions causes the control circuitry to increase thrust motor output when the float signal indicates that the gearbox is in a first position relative to the carriage and reduce thrust motor output when the float signal indicates that the gearbox is in a second position relative to the carriage, wherein the first position is distal of the second position.

4. The horizontal direction drilling machine of claim 1, wherein processor execution of the stored program instructions causes the control circuitry to determine the number of turns the distal end coupling is threaded into the proximal end of the drill rod by counting the number of revolutions of the spindle as indicated by the rotation encoder sensor when the float signal indicates that the gearbox has moved proximally with respect to the carriage after a change in output by the thrust motor.

5. The horizontal direction drilling machine of claim 4, wherein processor execution of the stored program instructions causes the control circuitry to decrease output of the thrust motor based on the determined number of turns the distal end coupling is threaded into the proximal end reaching a predetermined value, the predetermined value based on the quantity of threads in the proximal end of the drill rod.

6. The horizontal direction drilling machine of claim 1, wherein the vise assembly further comprises a distal vise distal of the proximal vise and processor execution of the stored program instructions causes the control circuitry to:
clamp the distal vise around the proximal end of the drill string;
rotate the spindle by increasing the output of the rotation motor;
determine the number of turns the distal end coupling is threaded into the proximal end of the drill rod by counting the number of revolutions of the spindle as indicated by the rotation encoder sensor when the float signal indicates that the gearbox has moved proximally with respect to the carriage after a change in output by the thrust motor that moves the distal end coupling of the spindle toward the proximal end of the drill rod; and
reduce the output of the rotation motor based on the determined number of turns the distal end coupling is threaded into the proximal end of the drill rod reaching a predetermined value, the predetermined value based on the quantity of threading in the proximal end of the drill rod.

7. The horizontal direction drilling machine of claim 6, wherein processor execution of the stored program instructions causes the control circuitry to increase thrust motor output when the float signal indicates that the gearbox is in a first position relative to the carriage and reduce thrust motor output when the float signal indicates that the gearbox is in a second position relative to the carriage while the distal end coupling is threaded into the proximal end of the drill rod, wherein the first position is distal of the second position with respect to the carriage.

8. The horizontal direction drilling machine of claim 1, wherein the vise assembly further comprises a distal vise distal of the proximal vise and processor execution of the stored program instructions causes the control circuitry to:
move the drill string by controlling the output of the thrust motor so that a proximal end of the drill string is within the distal vise as indicated by the rack encoder signal;
clamp the distal vise around the proximal end of the drill string and clamp the proximal vise onto the drill rod;
rotate the proximal vise relative to the distal vise;
unclamp the proximal vise;
move the drill rod to a predetermined position by controlling the output of the thrust motor, the output of the thrust motor based on the rack encoder signal indicating the position of the drill string with respect to the proximal vise;
clamp the proximal vise onto the drill rod while the drill rod is in the predetermined position as indicated by the rack encoder signal;
rotate the spindle relative to the drill rod while determining the number of turns the distal end coupling is unthreaded from the proximal end of the drill rod by counting the number of revolutions of the spindle as indicated by the rotation encoder sensor; and
expand a distance between the proximal vise and the distal end coupling of the spindle by increasing output of the thrust motor based on the rack encoder sensor.

9. The horizontal direction drilling machine of claim 1, wherein the vise assembly further comprises a distal vise distal of the proximal vise and processor execution of the stored program instructions causes the control circuitry to store in memory rack encoder signal values and float signal values indicating the relative positioning of the carriage relative to the rack and the carriage relative to the gearbox in each of the following positions and control output of the thrust motor to have the horizontal directional drilling machine assume each of these positions upon receiving one or more signals:
the drill rod is within the proximal vise while a drill string to which the drill rod is attached is within the distal vise;
the drill rod is within the proximal vise while the drill rod is unattached to the drill string and the distal end coupling of the spindle is threadedly coupled to the proximal end of the drill rod; and
the drill rod is within the proximal vise while the distal end coupling of the spindle is unattached to the proximal end of the drill rod.

10. A method for horizontal directional drilling, comprising:
providing a horizontal directional drilling machine having rack frame, a carriage longitudinally movable along the rack frame, a mechanical arrangement that controls relative movement between the carriage and the rack frame coupled to the carriage and the rack frame, a thrust motor coupled to the carriage such that thrust or pullback output from the thrust motor moves the carriage relative to the rack frame, a gearbox mounted on the carriage in a manner such that the gearbox is longitudinally movable along the carriage, a spindle attached to the gearbox, a rotation motor that rotates the spindle, and a distal end coupling of the spindle configured to attach to the proximal end of a drill rod, and a proximal vise that is linearly and rotationally moveable with respect to the rack frame;
outputting a rotation encoder signal from a rotation encoder sensor, the rotation encoder signal indicative of rotation of the spindle;
outputting a rack encoder signal from a rack encoder sensor, the rack encoder signal indicative of relative movement between the carriage and the rack frame;
outputting a float signal from a float sensor, the float signal indicative of relative movement between the carriage and the gearbox;
determining the relative positioning of the spindle relative to the proximal vise based on the rack encoder signal and the float signal;
moving the drill rod within the proximal vise based on the determined relative positioning of the spindle and the thrust motor;
determining a state of threaded coupling between the drill rod and a drill string based on the rotation encoder signal and the float signal; and
rotating the drill rod using the spindle rotated by the rotation motor, rotation of the drill rod based on the determined state of the threaded coupling.

11. The method for horizontal directional drilling of claim 10, further comprising applying a force between the gearbox and the carriage that pushes the gearbox in the distal direction relative to the carriage, and changing the output of the thrust motor based in part on the position of the gearbox along the carriage as indicated by the float signal.

12. The method for horizontal directional drilling of claim 11, further comprising increasing thrust motor output when the float signal indicates that the gearbox is in a first position relative to the carriage, and reducing thrust motor output when the float signal indicates that the gearbox is in a second position relative to the carriage, wherein the first position is distal of the second position.

13. The method for horizontal directional drilling of claim 10, further comprising determining the number of turns the distal end coupling is threaded into the proximal end of the drill rod by counting the number of revolutions of the spindle as indicated by the rotation encoder sensor when the float signal indicates that the gearbox has moved proximally with respect to the carriage after a change in output by the thrust motor.

14. The method for horizontal directional drilling of claim 13, further comprising decreasing output by the thrust motor based on the determined number of turns the distal end coupling is threaded into the proximal end reaching a predetermined value, the predetermined value based on the quantity of threads in the proximal end of the drill rod.

15. The method for horizontal directional drilling of claim 10, further comprising:
providing a distal vise distal of the proximal vise;
clamping the distal vise around the proximal end of the drill string;
rotating the spindle by increasing the output of the rotation motor;
determining the number of turns the distal end coupling is threaded into the proximal end of the drill rod by counting the number of revolutions of the spindle as indicated by the rotation encoder sensor when the float signal indicates that the gearbox has moved proximally with respect to the carriage after a change in output by the thrust motor that moves the distal end coupling of the spindle toward the proximal end of the drill rod; and
reducing the output of the rotation motor based on the determined number of turns the distal end coupling is threaded into the proximal end of the drill rod reaching a predetermined value, the predetermined value based on the quantity of threads in the proximal end of the drill rod.

16. The method for horizontal directional drilling of claim 15, further comprising:
increasing thrust motor output when the float signal indicates that the gearbox is in a first position relative to the carriage; and
reducing thrust motor output when the float signal indicates that the gearbox is in a second position relative to the carriage while the distal end coupling is threaded into the proximal end of the drill rod, wherein the first position is distal of the second position.

17. The method for horizontal directional drilling of claim 10, further comprising:
providing a distal vise distal of the proximal vise;
moving the drill string by controlling the output of the thrust motor so that a proximal end of the drill string is within the distal vise as indicated by the rack encoder signal;
clamping the distal vise onto the proximal end of the drill string and clamping the proximal vise onto the drill rod;
rotating the proximal vise relative to the distal vise to loosen threading between the drill rod and the drill string;
unclamping the proximal vise;
moving the drill rod to a predetermined position by controlling the output of the thrust motor, the output of the thrust motor based on the rack encoder signal indicating the position of the drill string with respect to the proximal vise;
clamping the proximal vise onto the drill rod while the drill rod is in the predetermined position as indicated by the rack encoder signal;
rotating the spindle relative to the drill rod while determining state of unthreading the proximal end of the drill rod based on a change in the float signal during rotation of the spindle; and
expanding a distance between the proximal vise and the distal end coupling of the spindle by increasing output of the thrust motor based on the rack encoder sensor.

18. The method for horizontal directional drilling of claim 10, further comprising:
providing a distal vise distal of the proximal vise;
saving rack encoder signal values and float signal values indicating the relative positioning of the carriage relative to the rack and the carriage relative to the gearbox when:
the horizontal directional drilling machine is in a first position, wherein the drill rod is within the proximal vise while a drill string to which the drill rod is attached is within the distal vise;
the horizontal directional drilling machine is in a second position, wherein the drill rod is within the proximal vise while the drill rod is unattached to the drill string and the distal end coupling of the spindle is threadedly coupled to the proximal end of the drill rod; and
the horizontal directional drilling machine is in a third position, wherein the drill rod is within the proximal vise while the distal end coupling of the spindle is unattached to the proximal end of the drill rod; and
moving the rack and the carriage relative to one another using the thrust motor to position the horizontal directional drilling machine in each of the first, second, and third positions using the saved rack encoder signal values and float signal values.

19. A horizontal directional drilling machine, comprising:
a rack frame;
a carriage longitudinally movable along the rack frame;
a mechanical arrangement coupled to the carriage and the rack frame, the mechanical arrangement controlling relative movement between the carriage and the rack frame;
a thrust motor coupled to the carriage such that thrust or pullback output from the thrust motor moves the carriage relative to the rack;
a gearbox mounted on the carriage, the gearbox longitudinally movable along the carriage, the gearbox comprising a rotation motor;
a spindle attached to the gearbox, the spindle rotatable by the rotation motor and having a distal end coupling, the distal end coupling configured to attach to the proximal end of a drill rod;
a vise assembly mounted on the rack frame, the vise assembly comprising a proximal vise linearly and rotationally moveable with respect to the rack frame, the proximal vise comprising a clamping mechanism configured to secure the drill rod by clamping onto the drill rod;
a rotation encoder sensor configured to output a rotation encoder signal indicative of rotation of the spindle;
a rack encoder sensor configured to output a rack encoder signal indicative of relative movement between the carriage and the rack;
a float sensor configured to output a float signal indicative of relative movement between the carriage and the gearbox;
means for determining the relative positioning of the spindle relative to the proximal vise based on the rack encoder signal and the float signal;
means for positioning the drill rod within the proximal vise using the determined relative positioning of the spindle and the thrust motor;
means for determining a state of threaded coupling between the drill rod and a drill string based on the rotation encoder signal and the float signal; and
means for rotating the drill rod using the spindle rotated by the rotation motor based on the determined state of the threaded coupling.

20. The horizontal directional drilling machine of claim 19, further comprising:
means for applying a force between the gearbox and the carriage that pushes the gearbox in the distal direction relative to the carriage; and
means for changing the output of the thrust motor based in part on the position of the gearbox along the carriage as indicated by the float signal.

21. The horizontal directional drilling machine of claim 20, further comprising:
means for increasing thrust motor output when the float signal indicates that the gearbox is in a first position relative to the carriage; and
means for reducing thrust motor output when the float signal indicates that the gearbox is in a second position relative to the carriage, wherein the first position is distal of the second position with respect to the carriage.

22. The horizontal directional drilling machine of claim 20, further comprising means for determining the number of turns the distal end coupling is threaded into the proximal end of the drill rod by counting the number of revolutions of the spindle as indicated by the rotation encoder sensor when the float signal indicates that the gearbox has moved proximally with respect to the carriage after a change in output by the thrust motor.

23. The horizontal directional drilling machine of claim 13, further comprising means for decreasing output by the thrust motor based on the determined number of turns the distal end coupling is threaded into the proximal end approaching a predetermined value, the predetermined value based on the quantity of threading in the proximal end of the drill rod.
